(19) United States
(12) Patent Application Publication
(10) Pub. No.: US 2004/0246323 A1
(43) Pub. Date: Dec. 9, 2004

(54) Image forming method

(76) Inventor: Wataru Ishikawa, Tokyo (JP)

Correspondence Address: CANTOR COLBURN LLP, 55 Griffin Road South, Bloomfield, CT, 06002, US

(21) Appl. No.: 10/854,988

(22) Filed: May 27, 2004

(30) Foreign Application Priority Data
Jun. 4, 2003 (JP) JP2003-159127

(51) Int. Cl. B41J 2/01

(52) U.S. Cl. 347/102

(57) ABSTRACT

A method for forming an image with an ink-jet printer, the ink-jet printer being provided with: (i) a recording head having a plurality of nozzles; and (ii) a radiation means to irradiate an ink ejected on a recording media, wherein the method comprises the steps of: (a) ejecting droplets of the ink from the nozzles on the recording media, provided that: (1) the ink contains a cationic polymerizable monomer and a photo acid generating agent; (2) the recording media has a surface pH value of not less than 6; and (3) a volume of each droplets is from 2 to 10 pl, (b) irradiating the ejected droplets of the ink on the recording media within a period of time between 0.01 and 1.0 second after arrival of the droplets on the recording media.

### TECHNICAL FIELD

The present invention relates to a method for forming an image using an ink-jet printer, in particular, a method which enables to produce an image of high resolution.

### BACKGROUND

In recent years, ink-jet recording methods have found wide application in the field of various kinds of graphic arts such as photography, various kinds of printing, marking and specific printing such as color filters due to its ability to form images simply and cheaply. Particularly, it has also become possible to obtain image quality comparable with silver salt photography by utilizing a recording apparatus which ejects and controls minute dots; ink in which color reproduction range, durability and ejection suitability have been improved; and exclusive paper in which ink absorption, color forming property of the colorant and surface gloss have been greatly enhanced. Image quality improvement of current ink-jet recording methods has been achieved only when complete set of a recording apparatus, ink and exclusive paper are employed as a system.

However, an ink-jet system which requires exclusive paper is problematic with respect to limitations of recording media and increased cost of such recording media. Therefore, many attempts have been made to record on a medium, on which ink is to be transferred, differing from exclusive paper by means of ink-jet recording. Specifically, there are phase-conversion ink-jet methods utilizing wax which is solid at room temperature, solvent-type ink-jet methods utilizing an ink which is comprised mainly of a rapid-drying organic solvent, and UV ink-jet methods in which an ink is cross-linked by ultraviolet (UV) light after recording.

Among these, the UV ink-jet methods have been noted recently due to rapid drying of prints and the capability of recording on a recording medium without ink absorptive property.

Such UV-curable ink-jet inks are disclosed in an examined Japanese Patent Publication No. 5-54667, an unexamined published Japanese Patent Publication (JP-A) No. 6-200204, and Japanese translated PCT Patent Publication No. 2000-504778. It is disclosed water-soluble photo-curable resin composition using a polymerizable compound having at least two polymerizable functional groups and one or two anionic functional groups in the molecule. (e.g.: Patent documents 1 and 2)

Two types UV-curable ink-jet inks are known: one contains a radical polymerizable monomer; and the other contains a cation polymerizable monomer. An ink containing a radical polymerizable monomer tends to have a problem of odor due to a monomer and photoinitiator. In addition, it may have a problem of giving an increased shrinkage of an ink layer after being polymerized.

On the other hand, an ink containing a cation polymerizable monomer has an advantage of giving a small amount of odor; and the shrinkage of an ink layer is not large.

However, after our investigation it was found that, an ink containing a cation polymerizable monomer tends to decrease a hardening property and adhesion ability when the surface pH value of the recording material is high.

[Patent document]

JP-A No. 2000-186243 (Claims of the invention)

[Patent document]

JP-A No. 2002-187918 (Claims of the invention)

### SUMMARY

In view of the above-described problems, the present invention is attained. By using an ink which contains a cationic polymerization monomer, an image of high resolution can be achieved on a surface of high pH value without deteriorating a hardening property and adhesiveness of the ink.

An object of the present invention is to provide a method which enables to form an image of high resolution with a low amount of smell, high adhesiveness and a high hardening property.

The present invention can be achieved by the following structures.

An aspect of the present invention includes a method for forming an image with an ink-jet printer, the ink-jet printer being provided with:

(i) a recording head having a plurality of nozzles; and

(ii) a radiation means to irradiate an ink ejected on a recording media,

wherein the method comprises the steps of:

(a) ejecting droplets of the ink from the nozzles on the recording media, the ink containing a cationic polymerizable monomer and a photo acid generating agent; the recording media having a surface pH value of not less than 6; and a volume of each droplet being in a range of 2 to 10 pl,

(b) irradiating the droplets of the ink ejected on the recording media within a period of time between 0.01 and 1.0 second after arrival of the droplets on the recording media.

### BRIEF DESCRIPTION OF DRAWINGS

FIG. 1 is a schematic front view showing a structure of an ink-jet printer used for an image forming method of the present invention.

### DETAILED DESCRIPTION

The present invention is achieved by finding an optimum condition for forming an image using a photo curable ink with an ink-jet printer. In order to obtain an optimum effect, the amount of each ink-jet droplet jetted from a nozzle of an ink-jet head, the timing of radiation after reach of an ink droplet to a recording material and a composition of a photo curable ink are adjusted.

The ink-jet head used for the present invention is preferably provided with a plurality of nozzles lined in a raw.

Another aspects of the present invention include the following embodiments:

A method for forming an image with an ink-jet printer, wherein the ink comprises a colorant.

A method for forming an image with an ink-jet printer, wherein the recording media has a surface pH value of not less than 7.

A method for forming an image with an ink-jet printer, wherein the cationic polymerizable monomer contained in the ink is an oxetane compound.

A composition of a photo curable ink, a condition of forming an image with an ink-jet printer and a recording material for the present invention will be detailed below.

Examples of cationic polymerizable monomers (hereafter are also referred to as cationic polymerizable photocurable resins) used in the present invention are such as UV curable pre-polymers of epoxy type (UV curable monomer). Examples of UV curable monomers are compounds having at least 2 epoxy groups in the molecule, e.g. alicyclic polyepoxide, polyglycidyl ester of polybasic acid, polyglycidyl ether of polyol, polyglycidyl ether of polyoxyalkylene glycol, polyglycidyl ester of aromatic polyol, polyglycidyl ether of aromatic polyol, urethane polyepoxy compound, and polyepoxy polybutadiene. Each of the aforementioned pre-polymers can be used solely or mixed with each other.

Other examples of cationic polymerizable monomers incorporated in the cationic polymerizable composition are, (1) styrene derivatives; (2) vinylnaphthalene derivatives; (3) vinyl ethers; and (4) N-vinyl compounds, which are exemplified as below.

(1) Styrene Derivatives:

e.g. styrene, p-methylstyrene, p-methoxystyrene, β-methylstyrene, p-methyl-β-methylstyrene, α-methylstyrene and p-methoxy-β-methylstyrene.

(2) Vinyl Naphthalene Derivatives:

e.g. 1-vinylnaphthalene, α-methyl-1-vinylnaphthalene, β-methyl-1-vinylnaphthalene, 4-methyl-1-vinylnaphthalene and 4-methoxy-1-vinylnaphthalene.

(3) Vinyl Ethers:

e.g. isobutyl vinyl ether, ethyl vinyl ether, phenyl vinyl ether, p-methylphenyl vinyl ether, p-methoxyphenyl vinyl ether, α-methylphenyl vinyl ether, β-methylisobutyl vinyl ether and β-chloroisobutyl vinyl ether.

(4) N-vinyl Compounds

e.g. N-vinylcarbazole, N-vinylpyrrolidone, N-vinylindole, N-vinylpyrrole, N-vinylphenothiazine, N-vinylacetoanilide, N-vinylethylacetoamide, N-vinylsuccinimide, N-vinylphthalimide, N-vinylcaprolactam and N-vinylimidazole.

In the present invention, at least one of the epoxy compounds is preferably, an epoxy aliphatic acid ester or an epoxy aliphatic acid glyceride.

An oxetane compound of the present invention will be described.

<<A Compound Having a Substituent at the 2-position of the Oxetane Ring in the Molecule>>

In the present invention, an oxetane compound has preferably an oxetane ring represented by General Formula (1) in the molecule.

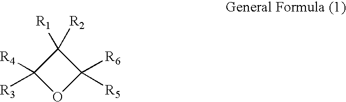

wherein, R₁-R₆ each represents a hydrogen atom or a substituent, however, at least one of the groups represented by R3-R6 is a substituent.

In General Formula (1), R₁-R₆ each represents a hydrogen atom, a fluorine atom or an alkyl group having 1-6 carbon atoms (e.g., a methyl group, an ethyl group, a propyl group or a butyl group), an fluorinated alkyl group having 1-6 carbon atoms, an ally group, an aryl group (e.g., a phenyl group, a naphtyl group, a furyl group or a thienyl group. These may further have a substituent.

<<An Compound Having an Oxetane Ring in the Molecule>>

Among compounds represented by General Formula (1), a more preferable compound is represented by General Formulas (2)-(5) described below.

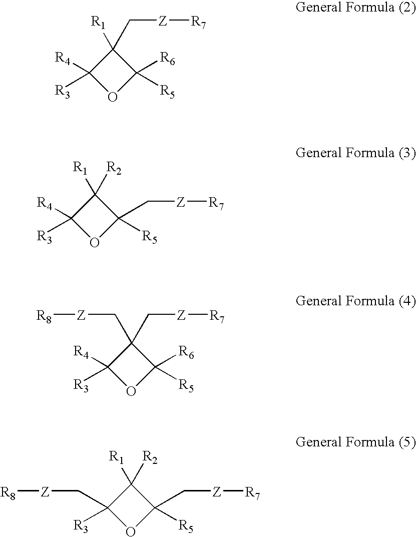

In General Formula (2) to (5), R₁-R₆ each represents a hydrogen atom or a substituent, R₇ and R₈ each represents a substituent, Z represent independently an oxygen atom or a sulfur atom, or a divalent hydrocarbon group which may have an oxygen atom or a sulfur atom in the main chain.

In General Formula (2) to (5), the substituents represented by R₁-R₆ designate the same substituent as by R₁-R₆ in General Formula (1).

R₇ and RB₈ in General Formula (2) to (5) each represents an alkyl group having 1-6 carbon atoms (e.g., a methyl group, an ethyl group, a propyl group or a butyl group), an alkenyl group having 1-6 carbon atoms (e.g., a 1-propenyl group, a 2-propenyl group, a 2-methyl-1-propenyl group, a 2-methyl-2-propenyl group, a 1-butenyl group, a 2-butenyl group, or a 3-butenyl group), an aryl group (e.g., a phenyl group, a benzyl group, a fluorobenzyl group, a methoxybenzyl group or a phenoxybenzyl group), an alkylcarbonyl group having 1-6 carbon atoms (e.g., a propylcarbonyl group, a butylcarbonyl group, or a pentylcarbonyl group), an alkoxycarbonyl group having 1-6 carbon atoms (e.g., an ethoxycarbonyl group, a propoxycarbonyl group, or a butoxycarbonyl group), an alkylcarbamoyl group having 1-6 carbon atoms (e.g.,a propylcarbamoyl group or a butylpentylcarbamoyl group, or an alkoxy carbamoyl group having 1-6 carbon atoms (e.g., an ethoxycarbamoyl group).

Listed examples of Z in General Formulas (2) to (5) are, an alkylene group (e.g. ethylene group, trimethylene group, tetramethylene group, propylene group, ethylethyelene group, pentamethyelene group, hexamethyelene group, heptamethylene group, octamethylene group, nanomethyelene group, decamethyelen group); an alkenylene group (e.g. vinylene group, propenylene group); and an alkynylene group (e.g. ethynylene group, 3-pentynylene group). The carbon atom in the aforementioned alkylene group, alkenylene group and alkynylene group may be replaced with an oxygen atom or a sulfur atom.

Among the substituents mentioned above, a preferable group for R₁ is a lower alkyl group (e.g. methyl group, ethyl group, and propyl group), a more preferable group is an ethyl group.

Preferably groups for R₇ and R₈ are, propyl group, butyl group, phenyl group or benzyl group.

Z is preferably a hydrocarbon group without containing an oxygen atom or a sulfur atom (e.g. alkylene group, alkenylene group or alkynylene group).

<<An Oxetane Compound Having at Least Two Oxetane Groups in the Molecule>>

In the present invention, a compound represented by General Formulas (6) and (7) described below can be used.

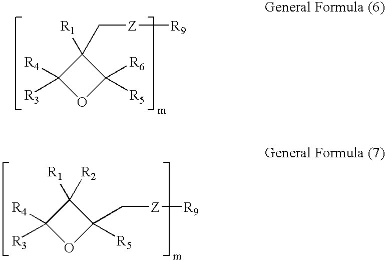

In General Formulas (6) and (7), Z designates the same as Z in Formulas (2) to (5); and m represents 2, 3, or 4.

R₁-R₆ each represents a hydrogen atom, a fluorine atom or an alkyl group having 1-6 carbon atoms (e.g., a methyl group, an ethyl group, a propyl group or a butyl group), an fluorinated alkyl group having 1-6 carbon atoms, an ally group, an aryl group, a furyl group. In General Formulas (6), at least one of R₃-R₆ is a substituent.

R₉ represents a straight or branched alkylene group having 1-12 carbon atoms, or a divalent group represented by General Formulas (9), (10) or (11).

Examples of branched alkylene groups having 1-12 carbon atoms are represented by General Formula (8) described below.

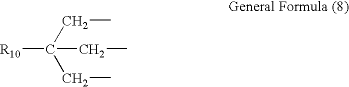

wherein R₁₀ represents a lower alkyl group (e.g., a methyl group, an ethyl group, or a propyl group).

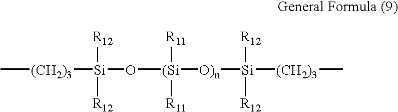

In General Formula (9), n represents 0 or an integer of 1-2,000, R₁₁ represents an alkyl group having 1-10 carbon atoms or the group represented by General Formula (12) described below.

R₁₂ represents an alkyl group having 1-10 carbon atoms (e.g., a methyl group, an ethyl group, a propyl group, a butyl group.

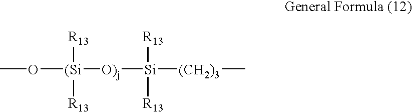

In General Formula (12), j represents 0 or an integer of 1-100, and R₁₃ represents an alkyl group having 1-10 carbon atoms (e.g., a methyl group, an ethyl group, a propyl group, a butyl group, a pentyl group, a hexyl group, a heptyl group, an octyl group, or a nonyl group).

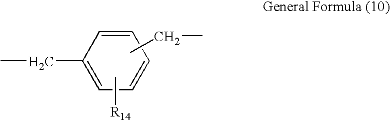

In General Formula (10), R₁₄ represents a hydrogen atom, an alkyl group having 1-10 carbon atoms (e.g., a methyl group, an ethyl group, a propyl group, a butyl group), an alkoxy group having 1-10 carbon atoms (e.g. a methoxy group, an ethoxy group, a propoxy group, a butoxy group, and a pentoxy group), a halogen atom (e.g., a fluorine atom, a chlorine atom, a bromine atom, or an iodine atom), a nitro group, a cyano group, a mercapto group, an alkoxycarbonyl group of lower alkyl number (e.g., a methyloxycarbonyl group, an ethyloxycarbonyl group, or a butyloxycarbonyl group), or a carboxyl group.

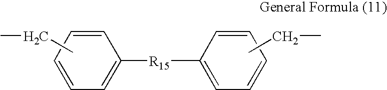

In General Formula (11), R₁₅ represents an oxygen atom, a sulfur atom, —NH—, —SO—, —SO₂—, —CH₂—, —C(CH₃)₂—, or —C (CF₃)₂—.

Embodiments of the preferred partial structure of compounds having an oxetane ring employed in the present invention are as follows. For example, in aforesaid General Formulas (6) and (7), R₁ is preferably a lower alkyl group (e.g., a methyl group, an ethyl group, or a propyl group), and is more preferably an ethyl group. Further, preferably employed as R₉ is a hexamethylene group or a group in which R₁₄ is a hydrogen atom in aforesaid General Formula (10).

In aforesaid General Formula (8), it is preferable that R₁₀ is an ethyl group, R₁₂ and R₁₃ each is a methyl group, and Z is a hydrocarbon group which contains neither an oxygen atom nor a sulfur atom.

Further, listed as one example of preferred embodiments of compounds having an oxetane ring according to the present invention is the compound represented by General Formula (13) described below.

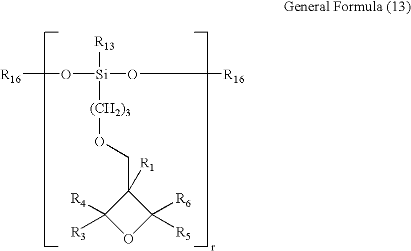

wherein r represents an integer of 25-200; R₁₆ represents an alkyl group having 1-4 carbon atoms (e.g., a methyl group, an ethyl group, a propyl group, or a butyl group), or a trialkylsilyl group; R₁, R₃, R₅, and R₆ each is the same as a substituent represented by each of R₁-R₆ in aforesaid General Formula (1), however, at least one of R₃-R₆ is a substituent.

Specific examples of compounds having an oxetane ring, in which position 2 is substituted, are shown as Exemplified Compounds 1-13. However, the present invention is not limited thereto.

1: trans-3-tert-butyl-2-phenyloxetane

2: 3,3,4,4-tetramethyl-2,2-diphenyloxetane

3: di[3-ethyl(2-methoxy-3-oxetanyl)]methyl ether

4: 1,4-bis(2,3,4,4-tetramethyl-3-ethyl-oxetanyl)butane

5: 1,4-bis(3-methyl-3-ethyloxetanyl)butane

6: di(3,4,4-trimethyl-3-ethyloxetanyl)methyl ether

7: 3-(2-ethyl-hexyloxymethyl)-2,2,3,4-tetramethyloxetane

8: 2-(2-ethyl-hexyloxy)-2,3,3,4,4-pentamethyl-oxetane

9: 4,4′-bis[(2,4-dimethyl-3-ethyl-3-oxetanyl)methoxy]biphenyl

10: 1,7-bis(2,3,3,4,4-pentamethyl-oxetanyl)heptane

11: oxetanyl silsesquioxane

12: 2-methoxy-3,3-dimethyloxane

13: 2,2,3,3-tetramethyloxetane

14: 2-(4-methoxyphenyl)-3,3-dimethyloxetane

15: di[2-(4- methoxyphenyl)-3-methyloxetane-3-yl]ether

It is possible to synthesize the compounds according to the present invention, which have an oxetane ring in which at least position 2 is substituted, with reference to publications described below.

(1) Hu Xianming, Richard M. Kellogg, Synthesis, 533-538, May (1995)

(2) A. O. Fitton, J. Hill, D. Ejane, R. Miller, Synth., 12, 1140 (1987)

(3) Toshiro Imai and Shinya Nishida, Can. J. Chem. Vol. 59, 2503-2509 (1981)

(4) Nobujiro Shimizu, Shintaro Yamaoka, and Yuho Tsuno, Bull. Chem. Soc. Jpn., 56, 3853-3854 (1983)

(5) Walter Fisher and Cyril A. Grob, Helv. Chim. Acta., 61, 2336 (1987)

(6) Chem. Ber. 101, 1850 (1968) (7) “Heterocyclic Compounds with Three- and Four-membered Rings”, Part Two, Chapter IX, Interscience Publishers, John Wiley & Sons, New York (1964)

(8) Bull. Chem. Soc. Jpn., 61, 1653 (1988)

(9) Pure Appl. Chem., A29 (10), 915 (1992)

(10) Pure Appl. Chem., A30 (2 & amp;3), 189 (1993)

(11) Japanese Patent Application Open to Public Inspection No. 6-16804

(12) DE 10221858

(Content in Photocurable Ink)

The amount of compounds according to the present invention, which have an oxetane ring in which at least position 2 is substituted, in a photocurable ink is preferably 1-97 percent by weight, and is more preferably 30-95 percent by weight.

(Use of Oxetane Compounds in Combination with Other Monomers)

Further, compounds according to the present invention, which have oxetane ring(s) in which at least position 2 is substituted, may be employed individually or in combinations with two types which have different structures. Further, the aforesaid compound may be employed in combination with photopolymerizable compounds such as photopolymerizable monomers or polymerizable monomers described below. When employed in combinations, it is preferable that a mixture is prepared so that the amount of compounds having oxetane ring(s) in the aforesaid mixture is adjusted to 10-98 percent by weight. Still further, it is preferable that the amount of other photopolymerizable compounds such as photopolymerizable monomers and polymerizable monomers is adjusted to 2-90 percent by weight.

<<An Oxetane Compound Having a Substituent only at the 3-position of the Oxetane Ring in the Molecule>>

In the present invention, a known oxetane compound can be used in combination with an oxetane compound having a substituent at the 2-position. Preferable oxetane compound is an oxetane compound having a substituent only at the 3-position of the oxetane ring in the molecule.

Examples of an oxetane compound having a substituent only at the 3-position of the oxetane ring in the molecule are disclosed in JP-A Nos. 2001-220526 and 2001-310937.

An oxetane compound having a substituent only at the 3-position of the oxetane ring in the molecule is represented by General Formula (14).

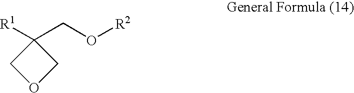

In the General Formula (14), R¹ is a hydrogen atom, alkyl group having 1-6 carbon atoms such methyl group, ethyl group, propyl group or butyl group, fluoro-alkyl group having 1 to 6 carbon atoms, allyl group, aryl group, furyl group, or thienyl group. R² is an alkyl group having 1 to 6 carbon atoms such as methyl group, ethyl group, propyl group or butyl group; alkenyl group having 2 to 6 carbon atoms such as 1-propenyl group, 2-propenyl group, 2-methyl-1-propenyl group, 2-methyl-2-propenyl group, 1-butenyl group, 2-butenyl group or 3-butenyl group; a group having aromatic ring such as phenyl group, benzyl group, fluoro-benzyl group, methoxy-benzyl group or phenoxy-ethyl group; alkyl carbonyl group having 2 to 6 carbon atoms such as ethyl carbonyl group, propyl carbonyl group or butyl carbonyl group; alkoxy carbonyl group having 2 to 6 carbon atoms such as ethoxy carbonyl group, propoxy carbonyl group or butoxy carbonyl group; N-alkyl carbamoyl group having 2 to 6 carbon atoms such as ethyl carbamoyl group, propyl carbamoyl group, butyl carbamoyl group or pentyl carbamoyl group. As the oxetane compound used in the present invention, it is particularly preferable that the compound having one oxetane ring is used, because the obtained composition is excellent in the coking property, and the operability is excellent in the low viscosity.

Next, as the compound having two oxetane rings, the compounds shown by the following General Formula (15) are listed.

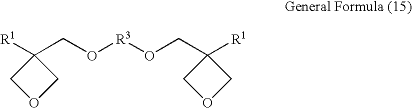

In the General Formula (15), R¹ is the same group as the group shown in the above-described General Formula (14). R³ is, for example, a linear or branching alkylene group such as ethylene group, propylene group or butylene group; linear or branching poly (alkylene-oxy) group such as poly (ethylene oxy) group or poly (propylene oxy) group; linear or branching un-saturated hydrocarbon group such as propenylene group, methyl propenylene group or butenylene group; carbonyl group; alkylene group including carbonyl group; alkylene group including carboxyl group; alkylene group including carbamoyl group.

Further, R³ may also be a polyvalent group selected from the group shown by the following General Formulas (16), (17) and (18).

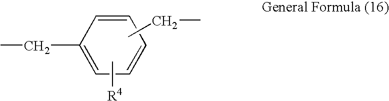

In the General Formula (16), R⁴ is a hydrogen atom, an alkyl group having 1 to 4 carbon atoms such as methyl group, ethyl group, propyl group or butyl group, or alkoxy group having 1 to 4 carbon atoms such as methoxy group, ethoxy group, propoxy group or butoxy group, or halogen atom such as chloride atom or bromine atom, nitro group, cyano group, mercapto group, lower alkyl carboxyl group such as the group having 1 to 5 carbon atoms, carboxyl group, or carbamoyl group.

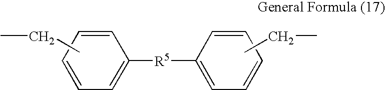

In the General Formula (17), R⁵ is oxygen atom, sulfide atom, methylene group, —NH—, —SO—, —SO₂—, —C(CF₃)₂—, or —C (CH₃)₂—.

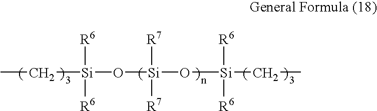

In the General Formula (18), R⁶ is an alkyl group having 1 to 4 carbon atoms such as methyl group, ethyl group, propyl group or butyl group, or aryl group. Numeral n is an integer of 0-2000. R⁷ is an alkyl group having 1 to 4 carbon atoms such as methyl group, ethyl group, propyl group or butyl group, or aryl group. R⁷ is also a group selected from the group shown by the following General Formula (19).

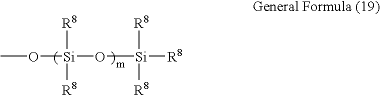

In the General Formula (19), R⁸ is an alkyl group having 1 to 4 carbon atoms such as methyl group, ethyl group, propyl group or butyl group, or aryl group. Numeral m is an integer of 0-100.

As a specific example of the compound having 2 oxetane rings, the compounds shown by the following structural formulas are listed.

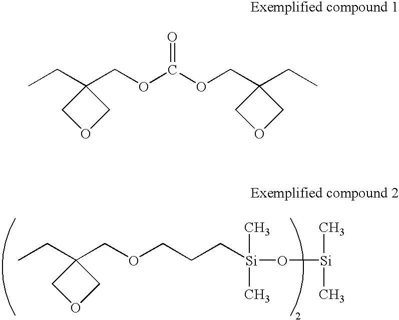

Exemplified compound 1 shown by the above structural formula is a compound in which R¹ is an ethyl group, and R³ is a carboxy group in General Formula (15).

Exemplified compound 2 shown by the above structural formula is a compound in which each R⁶ and R⁷ are a methyl group, and n is 1 General Formula (18).

Among the compound having 2 oxetane rings, as a preferable example except for the above-described compounds, there are compounds shown by the following General Formula (20). In the General Formula (20), R¹ is the same group as in the General Formula (14).

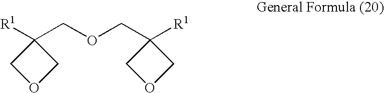

As the compounds having 3-4 oxetane rings, the compounds shown in the following General Formula (21) are listed.

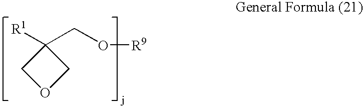

In the General Formula (21), R¹ is the same group as in the General formula (14). R⁹ is, for example, a branching alkylene group having 1 to 12 carbon atoms such as groups shown by the following Formulas A-C, or a branching poly(alkylene oxy) group such as group shown by the following Formula D.

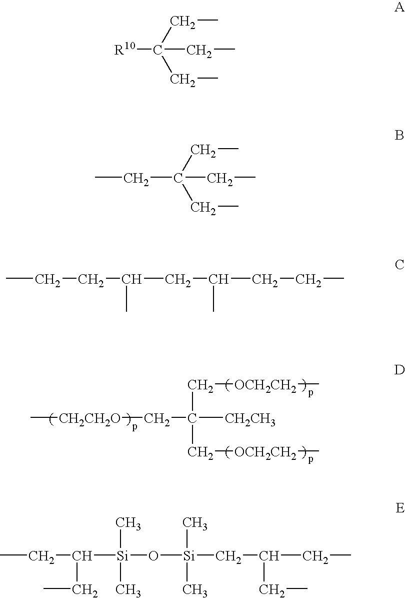

In Formula A, R¹⁰ is a lower alkyl group such as a methyl, ethyl, or propyl group. In Formula D, p is an integer of 1 to 10.

As the specific example of the compound having 3 to 4 oxetane rings, the compound shown in the following Exemplified compound 3 is cited.

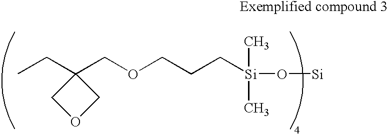

Furthermore, as an example of the compounds having 1-4 oxetane rings except the above examples, there are compounds shown in the following General Formula (22).

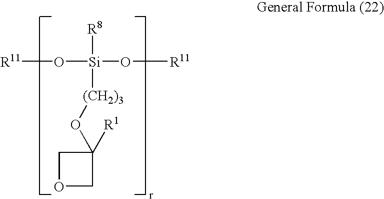

In the General Formula (22), R⁸ is the same group as in the General Formula (19). R¹¹ is alkyl group having 1 to 4 carbon atoms such as methyl group, ethyl group, propyl group or butyl group, or tri-alkyl silyl group, and numeral r is 1-4.

As preferable specific examples of the oxetane compounds used in the present invention, there are compounds 4-6 shown below.

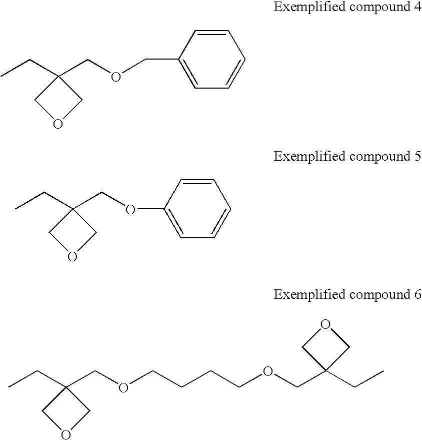

The production method of the compounds having the oxetane ring is not particularly limited, and it may be conducted according to the conventionally known method, and for example, there is a synthetic method of an oxetane ring from diol disclosed by Pattison (D. B. Pattison, J. Am. Chem. Soc., 3455, 79 (1957)).

Further, other than them, compounds having 1-4 oxetane rings, which have high molecular weight of molecular weight of about 1000-5000, are also listed. As an example of them, for example, the following compounds 7-9 are listed.

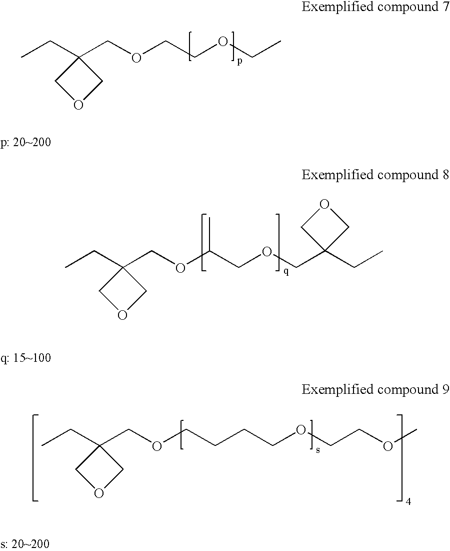

A photo acid generating agent used in the present invention is detailed below.

As a photo acid generating agents, the compounds used for the chemical amplification type photo resist or photo cation polymerization is used (Organic electronics material study group edition, “Organic material for imaging” Bunshin publication co., (1993), refer to page 187-192). Examples of the compounds preferable for the present invention will be listed below.

Example compounds used for the present invention are cited below.

Initially, the salt such as B(C₆F₅)₄⁻, PF₆⁻, AsF₆⁻, SbF₆⁻, CF₃SO3⁻ of the aromatic onium compound such as diazonium, ammonium, iodonium, sulfonium, phosphonium, can be listed.

Borate compounds are preferred due to high capacity to produce oxygen atom. Specific example of onium compound, which can be used in the present invention, will be shown blow.

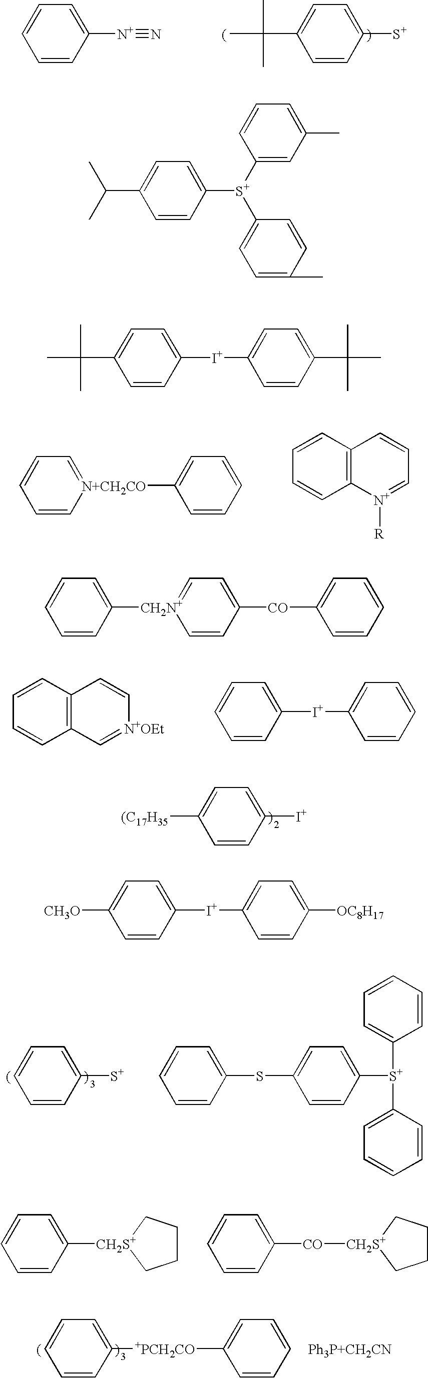

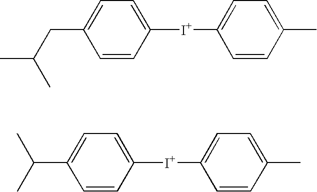

Secondly, the sulfonic compound generating the sulfonic acid can be listed. Its specific compound will be illustrated below.

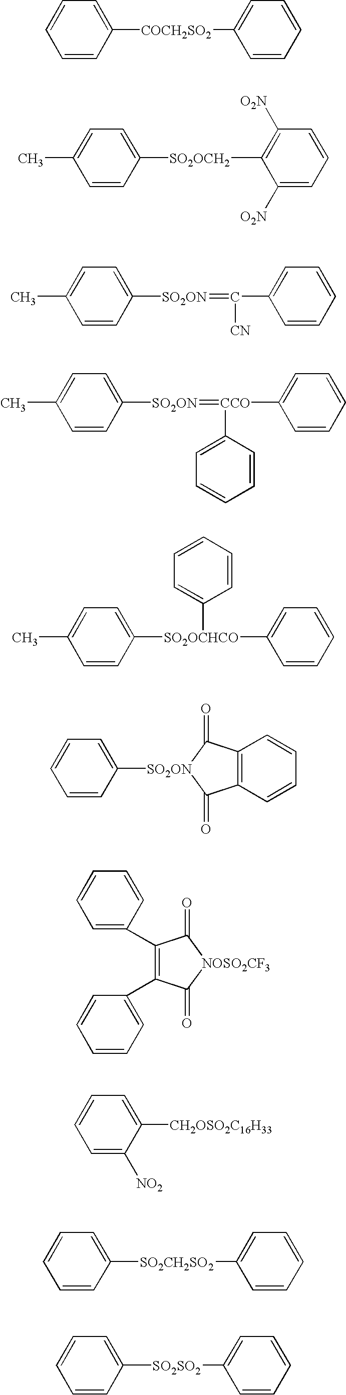

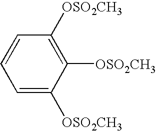

Thirdly, the halide compound generating the hydrogen halide can also be used. Its specific compound will be illustrated below.

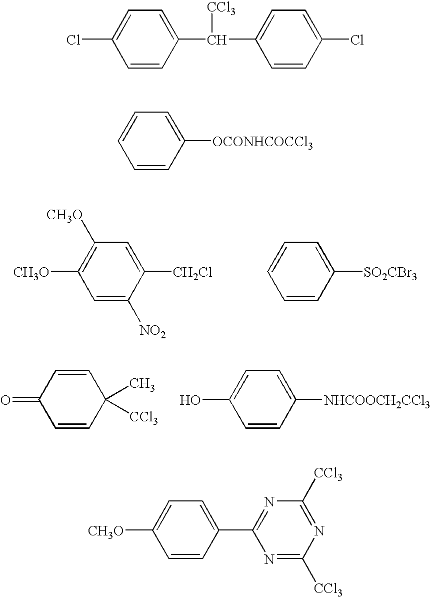

Fourthly, an iron π complex (ferrocene) can be listed.

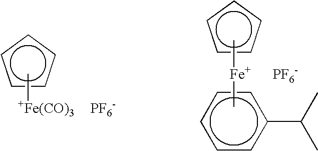

When ink according to the present invention is colored, colorants are incorporated.

Employed as colorants usable in the present invention may be conventionally known pigments and dyes. Listed as pigments may be, for example, various organic chromatic color pigments such as phthalocyanine based, azo based, quinacridone based, dioxanzine based, or diketopyropyrrole based pigments, and inorganic pigments such as carbon black, titanium white, silica, mica, and zinc oxide.

Suitably employed as organic pigments may be those listed below. Examples of yellow pigments include Pigment Yellow Pigment 1, Pigment Yellow 2, Pigment Yellow 3, Pigment Yellow 12, Yellow 13, Pigment Yellow 14, Pigment Yellow 16, Pigment Yellow 17, Pigment Yellow 55, Pigment Yellow 73, Pigment Yellow 74, Pigment Yellow 75, Pigment Yellow 83, Pigment Yellow 93, Pigment Yellow 95, Pigment Yellow 97, Pigment Yellow 98, Pigment Yellow 109, Pigment Yellow 110, Pigment Yellow 114, Pigment Yellow 128, Pigment Yellow 138, Pigment Yellow 139, Pigment Yellow 150, Pigment Yellow 151, Pigment Yellow 154, Pigment Yellow 155, and Pigment Yellow 180.

Listed as magenta pigments are, for example, Pigment Red 5, Pigment Red 7, Pigment Red 12, Pigment Red 48 (Ca), Pigment Red 48 (Mn), Pigment Red 57:1, Pigment Red 57 (Sr), Pigment Red 57:2, Pigment Red 122, Pigment Red 123, Pigment Red 146, Pigment Red 168, Pigment Red 184, Pigment Red 202, Pigment Red 221, Pigment Red 238, and Pigment Violet 19.

Listed as cyan pigments are, for example, Pigment Blue 1, Pigment Blue 2, Pigment Blue 3, Pigment Blue 16, Pigment Blue 22, Pigment Blue 60, Pigment Blue 15:2, Pigment Blue 15:3, Pigment Blue 15:4, Vat Blue 4, and Vat Blue 60.

When pigments are used as a colorant, it is preferable that water-based pigment dispersion in which the above pigments are uniformly dispersed into a water-based medium is employed and the resulting dispersion is mixed with water-soluble photocuring type resinous composition according to the present invention. It is also preferable to use water-based pigment dispersion in which pigments are stably dispersed in water by an anionic functional group. For example, it is possible to employ, without any modifications, water-based gravure ink, water-based writing pigment dispersion, and conventional prior art pigments dispersions for ink jet ink, which are stable in a nonionic system or an anionic system.

Pigment dispersions which are dispersed by alkali-soluble water-soluble polymers having an anionic dissociation group are disclosed, for example, in JP-A Nos. 5-247392 and 8-143802. Further, a pigment dispersion which is dispersed by surface active agents having an anionic dissociation group is disclosed in JP-A No. 8-209048. Still further, pigment dispersions which are dispersed in such a manner that encapsulation is carried out employing polymers and an anionic dissociation group is provided on the resulting surface are disclosed in JP-A Nos. 10-140065, 9-316353, 9-151342, 9-104834, and 9-31360. Still further, there are dispersions as disclosed in U.S. Pat. Nos. 5,837,045 and 5,851,280, in which pigment dispersions are prepared by dispersing pigments while combining an anionic dissociation group onto the surface of the pigments via chemical reaction.

Basic requirements for stable pigment dispersion which can be used for an ink jet recording ink are as follows. Pigments are dispersed in a water-based medium, and the particle size distribution in the resulting dispersion is 25 350 nm in terms of average particle diameter, the viscosity of the final ink is controllable in a range which adversely affect ink injection, and further, compatibility is satisfied with essential compounds which make the ink ultraviolet radiation curable.

Further, by controlling the average particle diameter of pigment particles in the range of about 35 nm-about 350 nm, which is less than the wavelength of visible light, printed matter with the desired transparency is provided under minimal scattered light, even though transparency varies depending on the use of the printed matter.

When pigments are employed as a colorant of ink, the concentration of the portion of genuine pigments is customarily in the range of 0.3-15 percent by weight of the total ink. Tinting strength of pigments depends on the dispersion state of the pigment particles. Concentration in the range of about 0.3-1 percent by weight refers to the range in which the ink is used as a pale ink. When the concentration exceeds the above range, density used for common tinting results.

Further, the composition ratio of the ink jet ink employed in the present invention is determined employing a pigment dispersion so that the viscosity of the ink composition reaches 10-500 mPa·s at 25° C. and 1-30 mPa·s when heated to at least 35° C.

By enhancing the viscosity at room temperature, it is possible to minimize ink penetration even into absorptive recording medium, to decrease uncured monomers, and to reduce unpleasant odors, as well as to minimize dot bleeding during deposition of ink droplets, whereby image quality is improved. Further, similar dots are formed on recording media exhibiting different surface tension, whereby similar image quality is achieved. When the viscosity is less than 10 mPa·s, the resulting bleeding resistant effect is minimal, while when it exceeds 300 mPa·s, feeding of ink liquid results in problems.

Further, in order to achieve stable ejection, it is preferable that the viscosity of the ink composition is 1-30 mPa·s.

During preparation of the ink of the present invention, employed raw materials may be mixed in any order. However, in order to assure stability during mixing, it is preferable that all the materials are previously regulated to be neutral or basic. During mixing, it is preferable to rapidly stir a mixture so that a non-uniform state is not maintained over an extended period. When a pigment dispersion is employed as a colorant, it is preferable that after mixing, the resulting mixture is well stirred so that uniformity is maintained.

An image forming method will now be described.

In the image forming method employing the ink of the present invention, after allowing the ink composition to adhere to a recording medium, it is exposed to actinic radiation is exposed. Radiation exposure may be either visible light exposure or ultraviolet radiation exposure. However, ultraviolet radiation exposure is particularly preferred. When ultraviolet radiation is exposed, the exposure amount is at least 100 mJ/cm², is preferably at least 500 mJ/cm² and at most 10,000 MJ/cm², and preferably in the range of at most 5,000 mJ/cm². An ultraviolet exposure amount in the range specified as above is advantageous because it makes it possible to sufficiently proceed with a curing reaction, and it is also possible to minimize discoloration of colorants due to ultraviolet radiation exposure. Listed as ultraviolet radiation sources are metal halide lamps, xenon lamps, carbon arc lamps, chemical lamps, low pressure mercury lamps, and high pressure mercury lamps. For example, it is possible to use commercially available radiation sources such as H lamp, D lamp, or V lamp, manufactured by Fusion System Co.

Metal halide lamps emit continuous spectral radiation compared to high pressure mercury lamps (at a dominant wavelength of 365 nm), exhibit high emission efficiency in a range of 200-450 nm, and emit abundant radiation in the long wavelength region. Accordingly, when pigments are employed, as ink compositions of the present invention, the above metal halide lamps are suitable.

In the present invention, after deposition of ink droplets onto a recording material and subsequently curing of the resulting ink, the thickness of the total ink layer is preferably 2-20 μm. In actinic radiation curable type ink jet recording in the screen printing field, at present, the thickness of the total ink layer exceeds 20 μm. In the soft package printing field in which recording materials are often comprised of thin plastic materials, in addition to the above-mentioned problems of curling and wrinkling of recording materials, problems occur in which stiffness and feel of quality of the entire printed matter vary. Consequently, excessive ink ejection, which results in a thick layer, is not preferred.

“Thickness of the total ink layer”, as described herein, refers to the maximum value of the thickness of an ink layer formed on a recording material. Even when recording is carried out employing an ink jet recording system of a single color, and other 2-color overlapping (secondary color), 3-color overlapping, and 4-color overlapping (white ink base), the thickness of the total ink layer is as defined above.

In view of ink ejection stability, ink ejection conditions are that recording heads as well as the ink are heated 35-100° C., and subsequently the ink is ejected. An actinic radiation curable ink results in a wide viscosity variation range depending on temperature variation. To a large extent, viscosity variation directly affects the size of liquid droplets and the rate of liquid droplet ejection, which degrades image quality. Consequently, it is necessary to maintain ink temperature even when heated. The control range of the desired ink temperature is commonly set temperature ±5° C., is preferably set temperature ±2° C., and is more preferably set temperature ±1° C.

Further, in the present invention, the volume of a liquid droplet ejected from each of the ejection outlets of a recording head is preferably 2-15 pl. Originally, in order to form highly detailed images, it is necessary that the volume of a droplet is within the above-mentioned range. When ejection is carried out at this volume of a droplet, it becomes particularly difficult to maintain the above-mentioned ejection stability. According to the present invention, even when ejection is carried out employing a small volume of liquid ink droplets such as 2-15 pl, it is possible to enhance ejection stability and to stably form highly detailed images.

In the image forming method of the present invention, exposure conditions to actinic radiation are that actinic radiation is exposed preferably 0.01-1.0 second after ink deposition, and more preferably 0.01-0.5 second after ink deposition.

A basic method of actinic radiation exposure methods is disclosed, for example, in JP-A No. 60-132767. According to the above, radiation sources are provided on both sides of a head unit, and the head and the radiation source are scanned employing a shuttle system. Exposure to actinic radiation is carried out the specified time after ink deposition. Further, curing is completed employing another radiation source which is not driven. U.S. Pat. No. 6,145,979 discloses a method which employs optical fiber as an exposure method for actinic radiation, and a method in which UV radiation is exposed to a recording section while allowing a collimated radiation source to be incident to the mirror surface provided on the side of a head unit. In the image forming method of the present invention, it is possible to use any of these exposure methods.

Further, the following method is also one of the preferred embodiments. Exposure to actinic radiation is divided into two stages. Initially, actinic radiation is exposed 0.01-1.0 second after ink deposition employing the above-mentioned method and after finishing printing of the entire sheet, it is further exposed to actinic radiation. By dividing exposure to actinic radiation into two stages, it is possible to minimize contraction of recording materials, which occurs during curing the ink.

Supports for the present invention are explained. In this invention, various types of non-absorptive supports can be used other than common coated paper and non-coated paper.

Examples of various types of plastic films including PET (polyethylene terephthalate) film, OPS (oriented polystyrene) film, OPP (oriented polypropylene) film, ONy (oriented nylon) film, PVC (polyvinyl chloride) film, PE film, and TAC film. Employed as other plastic films may be polycarbonate, acrylic resins, ABS, acetal, PVA, and rubber. Further, metal and glass may also be employed.

When cationic curable ink is used for printing on the above-described supports having a surface pH value of not less than 6.0, there may occur problems of insufficient hardening, decrease of adhesiveness or ink bleeding. In the present invention, a method of printing without such problems even on a surface pH value of not less than 6.0. Further, the present invention is more effective in printing on a surface pH value of not less than 7.0. The surface pH value of this invention can be obtained as follows:

(i) putting 0.1 ml of water on a surface of sample, the sample being kept at 23° C. with 48% RH;

(ii) left 5 minutes; then

(iii) measuring the pH.

In the present invention, form the viewpoint of the cost of recording materials such as packaging cost as well as production cost, print production efficiency, and compatibility with prints of various sizes, it is more advantageous to used long (web) recording materials.

The recording apparatus employed in the present invention will now be described with reference to a drawing when deemed necessary. Further, the recording apparatus in the drawing is one of the embodiments employed in the present invention, but the recording apparatus employed in the present invention is not limited thereto.

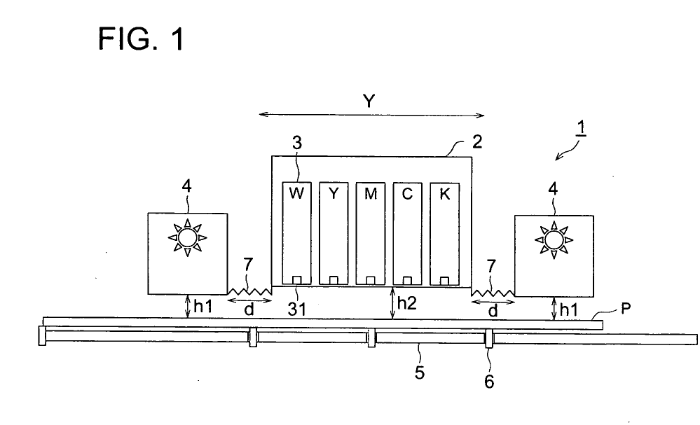

FIG. 1 is a front view showing the structure of the main section of the recording apparatus employed in the present invention. Recording apparatus 1 is comprised of head carriage 2, recording head 3, illumination means 4, and platen section 5. Platen section 5 exhibits an ultraviolet radiation absorbing function and absorbs extra ultraviolet radiation which has been transmitted through recording material P. As a result, it is possible to very consistently reproduce highly fine and detailed images.

Recording material P is guided by guide member 6 and moves from the front to the back of FIG. 1, utilizing operation of a transport means (not shown). A head scanning means (also not shown) allows head carriage 2 to reciprocate in the Y direction shown in FIG. 1 whereby scanning of recording head 3, held by head carriage 2, is carried out.

Head carriage 2 is arranged above recording material P, and houses a plurality of recording heads 3, described below, matching the number of colors employed for printing images onto recording material P so that ink ejection openings are arranged on the lower side. Head carriage 2 is arranged in the main body of recording apparatus 1 in such manner that reciprocal motion is allowed in the Y direction in FIG. 1. driven by the head scanning means.

Incidentally, FIG. 1 shows that head carriage 2 houses white (W), yellow (Y), magenta (M), cyan (C), and black (K) recording heads 3. However, in practice, the number of colors of recording head 3, which are housed in carriage 2, is decided on a need basis.

In the followings, Yellow recording head is explained as an example of recording head 3.

Recording heads 3 eject a photocurable ink (also called an actinic radiation curable ink such as an ultraviolet radiation curable ink), which is supplied by an ink supply means (not shown), onto recording material P from ejection openings, utilizing operation of a plurality of ejection means (also not shown) arranged in its interior. The ultraviolet radiation curable ink (also called UV ink), which is ejected from recording heads 3, is comprised of colorants, polymerizable monomers, initiators, and the like. When exposed to ultraviolet radiation, the aforesaid initiators work as a catalyst, whereby curing properties are exhibited through cross-linking and polymerization reaction of the aforesaid monomers.

During scanning in which recording heads 3 move from one end of recording material P to the other end thereof along the Y direction in FIG. 1, while driven by the head scanning means, aforesaid recording heads 3 eject the aforesaid UV ink in the form of ink droplets onto a definite region (an ink droplet receivable area) of recording material P and impinge ink droplets onto the aforesaid ink droplet receivable area.

The aforesaid scanning is carried out at a suitable frequency. The aforesaid UV ink is ejected onto the ink droplet receivable region. Thereafter, recording material P is appropriately conveyed from the front to the back of FIG. 1, employing a conveying means, and scanning is again carried out employing the head scanning means. During the aforesaid scanning, the aforesaid UV ink is ejected onto the following ink droplet receivable region adjacent to the backward direction of FIG. 1, while employing recording heads 3.

The aforesaid operation is then repeated. By ejecting the aforesaid UV ink from recording heads 3 while synchronizing the head scanning means with the conveying means, an image comprised of an assembly of UV ink droplets is formed on recording material P.

Exposure means 4 is comprised of an ultraviolet radiation lamp which emits ultraviolet radiation of a specified wavelength region at consistent exposure energy, and a filter which transmits the ultraviolet radiation of the specified wavelength. Herein, employed as ultraviolet radiation lamps may be mercury lamps, metal halide lamps, excimer lasers, ultraviolet lasers, cold cathode tubes, black-light lamps, and LEDs (light emitting diodes). Of these, preferred are band-shaped metal halide lamp tubes, cold cathode tubes, mercury lamps, or black-light lamps. Specifically, preferred are cold cathode tubes and black-light lamps which emit ultraviolet radiation of a wavelength of 365 nm, because bleeding is minimized, dot diameter is efficiently controlled, and wrinkling during curing is minimized. By employing the black light lamp as a radiation source of exposure means 4, it is possible to prepare exposure means 4 to cure the UV ink at a lower cost.

Exposure means 4 is shaped to be nearly equal to the maximum one which can be set by recording apparatus (being a UV ink-jet printer) 1 of the ink dot receivable region in which the UV ink is ejected during one frequency of scanning in which recording heads 3 are driven by the head scanning means, or is shaped to be larger than the ink dot receiving region.

Exposure means 4 are arranged and fixed on both sides of head carriage 2, being nearly parallel to recording material P.

As noted above, as a means to control illuminance in the ink ejection section, needless to say, entire recording heads 3 are shielded from light. In addition, it is effective that distance h2 between ink ejection section 31 of recording heads 3 and recording material P is adjusted to be greater than distance h1 between exposure means 4 and recording material P (i.e., h1<h2) and/or distance d between recording heads 3 and exposure means 4 increases (d increases). Further, it is more preferable that bellows structure 7 is applied between recording heads 3 and exposure means 4.

Herein, it is possible to suitably change the wavelength of ultraviolet radiation which is exposed employing exposure means 4 by replacing ultraviolet radiation lamps or filters fitted with exposure means 4.

### EXAMPLES

The present invention will now be described with reference to examples. However it is not limited thereto.

<<Preparation of Ink Composition>>

Ink compositions having the constitution described in Table 1 were prepared.

TABLE 1

| | | Ink | | | | |
|---|---|---|---|---|---|---|
| | | Composition | | | | |
| | | K | C | M | Y | W |
| Colorant | | Colorant | Colorant | Colorant | Colorant | Colorant |
| | | 1 | 2 | 3 | 4 | 5 |
| Added Amount | | 4 | 3 | 4 | 3 | 20 |
| Cationic | oxetane (OXT- | 67 | 63 | 67 | 68 | 46 |
| Polymerizable | 2121, | | | | | |
| Monomer | manufactured | | | | | |
| | by Toagosei | | | | | |
| | Chemical | | | | | |
| | Industry Co., | | | | | |
| | Ltd.) | | | | | |
| Cationic | epoxidated | 20 | 20 | 20 | 20 | 20 |
| Polymerizable | compound | | | | | |
| Monomer | (epoxidated | | | | | |
| | soybean oil, | | | | | |
| | manufactured | | | | | |
| | by Asahi Denka | | | | | |
| | Kogyo K.K.) | | | | | |
| Acid | Acid | 1 | 1 | 1 | 1 | 1 |
| Multiplying | Multiplying | | | | | |
| Agent | Agent 1 | | | | | |
| Thermally | Thermally | 2 | 2 | 2 | 2 | 2 |
| Base | Basic Group | | | | | |
| Generating | Generating | | | | | |
| Agent | Agent 1 | | | | | |
| Photo- | CS5102 | 5 | 10 | 5 | 5 | 10 |
| lytically | (manufactured | | | | | |
| Acid | by Nippon Soda | | | | | |
| Generating | Co., Ltd.) | | | | | |
| Agent | | | | | | |
| Initiator Aid | CI7001 | 1 | 1 | 1 | 1 | 1 |
| | (manufactured | | | | | |
| | by Nippon Soda | | | | | |
| | Co., Ltd.) | | | | | |

The abbreviations described in Table 1 are as follows:

K: black ink

C: cyan ink

M: magenta ink

Y: yellow ink

W: white ink

Colorant 1: C.I. Pigment Black 7

Colorant 2: C.I. Pigment Blue 15:3

Colorant 3: C.I. Pigment Red 57:1

Colorant 4: C.I. Pigment Yellow 13

Colorant 5: titanium oxide (anatase type at an average particle diameter of 0.20 μm)

Acid Multiplying Agent

Compound 1

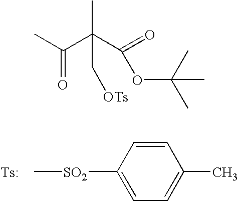

Thermally Base Generating Agent 1

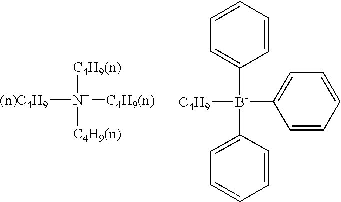

<<Ink Jet Image Forming Method>>

The ink jet printer provided with a piezo type ink jet head, shown in Table 1, was loaded with each of the ink composition sets, prepared as above, and image recording was continuously performed on each of the long recording media at a width of 600 mm and a length of 1,000 m, shown in Tale 2. The ink feeding system was comprised of an ink tank, a feeding pipe, a pipe arrangement with filters, and a piezo head. Heat was insulated from the pre-chamber ink tank to the head section and temperature was raised to 50° C. The piezo head was driven so that multi-sized dots of 2-14 pl were ejected at a resolution of 720×720 dpi (dpi refers to the number of dots per inch which equals 2.54 cm) and each ink was continuously ejected. After ink deposition onto the recording medium, curing was performed by exposure to ultraviolet radiation. Evaluation was carried out on location conditioned to 23° C. and 40 percent relative humidity.

The volume of ink liquid droplets per ejection in each of the image forming methods and duration (exposure timing) between the ink deposition and the exposure to ultraviolet radiation were controlled as shown in Table 2.

TABLE 2

| | | | Volume | | |
|---|---|---|---|---|---|
| | Recording Medium | | of | | |
| Image | | pH of | Liquid | | |
| Forming | Name of | Layer | Ink | Exposure | |
| Method | Recording | Sur- | Droplet | Timing | |
| No. | Medium | face | (pl) | (seconds) | Remarks |
| 1 | YUPO: FGS | 8.8 | 2 | 0.1 | Present |
| | (manufactured | | | | Invention |
| | by YUPO Corp.) | | | | |
| 2 | WP110 | 8.8 | 2 | 0.1 | Present |
| | (manufactured | | | | Invention |
| | by Nisshinbo | | | | |
| | Industries, | | | | |
| | Inc.) | | | | |
| 3 | YUPO: GWG | 6.2 | 2 | 0.1 | Present |
| | (manufactured | | | | Invention |
| | by YUPO Corp.) | | | | |
| 4 | PET | 6 | 2 | 0.1 | Present |
| | | | | | Invention |
| 5 | Coated Paper: | 7.5 | 2 | 0.1 | Present |
| | OK Coat | | | | Invention |
| 6 | Tarpaulin | 7.5 | 2 | 0.1 | Present |
| | | | | | Invention |
| 7 | YUPO: FGS | 8.8 | 8 | 0.1 | Present |
| | (manufactured | | | | Invention |
| | by YUPO Corp.) | | | | |
| 8 | YUPO: FGS | 8.8 | 14 | 0.1 | Comparative |
| | (manufactured | | | | Example |
| | by YUPO Corp.) | | | | |
| 9 | Tarpaulin | 7.5 | 14 | 0.1 | Comparative |
| | | | | | Example |
| 10 | YUPO: FGS | 8.8 | 2 | 0.06 | Present |
| | (manufactured | | | | Invention |
| | by YUPO Corp.) | | | | |
| 11 | YUPO: FGS | 8.8 | 2 | 2 | Comparative |
| | (manufactured | | | | Example |
| | by YUPO Corp.) | | | | |
| 12 | Tarpaulin | 7.5 | 2 | 2 | Comparative |
| | | | | | Example |

Exposure radiation sources and exposure methods are detailed below.

Exposure radiation source: fluorescent lamp (power consumption less than 1 kw/hour, special order product manufactured by NIPPO Electric Co., Ltd.)

Exposure method: exposure employing a linear radiation source from both ends of a recording head

<<Evaluation of Ink Jet Recording Images>>

Each of the images recorded by the above-mentioned image recording method was subjected to each evaluation below.

(Evaluation of Color Bleeding=Evaluation of Detail)

Adjacent dots of each color were enlarged by a hand magnifier, and the degree of bleeding was visually observed. Subsequently, color mixing resistance was evaluated based on the criteria below, and the average rank of each color was recorded.

A: the shape of adjacent dots maintained circularity and exhibited no bleeding

B: the shape of adjacent dots maintained near circularity and exhibited almost no bleeding

C: the shape of adjacent dots was slightly deformed due to bleeding, but at the lowest level for commercial viability]

D: adjacent dots exhibited bleeding and mixing, and were at a level of no commercial viability

(Evaluation of Close Adhesion)

After printing 4C solid images and curing the resulting images, close adhesion was evaluated by peeling adhered Cellotape (a registered trade mark).

A: no peeling was noticed

B: slight peeling was noticed, but resulted in no problem

C: peeling was noticed but was at the lowest level of commercial viability

D: peeling was noticed and was beyond the limit for commercial viability

(Evaluation of Curing)

A: ink was completely cured and was not removed by rubbing with fingers

B: ink was removed by vigorous rubbing with fingers

C: ink was removed by rubbing with fingers but at the lowest level of commercial viability

D: ink was removed by rubbing and was beyond the limit of commercial viability

Table 3 shows the evaluation results. Incidentally, during image formation, almost no unpleasant odors due to inks were noticed.

TABLE 3

| Image | | Close | | |
|---|---|---|---|---|
| Forming | | Adhesion | | |
| Method No. | Curability | Property | Detail | Remarks |
| 1 | A | B | A | Present Invention |
| 2 | A | B | A | Present Invention |
| 3 | A | A | A | Present Invention |
| 4 | A | A | A | Present Invention |
| 5 | A | A | A | Present Invention |
| 6 | A | A | A | Present Invention |
| 7 | B | B | B | Present Invention |
| 8 | D | D | D | Comparative |
| | | | | Example |
| 9 | C | D | D | Comparative |
| | | | | Example |
| 10 | A | A | A | Present Invention |
| 11 | C | D | D | Comparative |
| | | | | Example |
| 12 | B | D | D | Comparative |
| | | | | Example |

Based on the results of Table 3, it was noticed that even in a recording media of a high layer surface pH, highly detailed images which exhibited excellent adhesion property and curability were prepared employing the image forming method of the present invention.

According to the present invention, it is possible to provide an image forming method which forms highly detailed images exhibiting minimal unpleasant odors, as well as excellent adhesion property and curability, employing general purpose recording media.

What is claimed is:

1. A method for forming an image with an ink-jet printer, the ink-jet printer being provided with:
(i) a recording head having a plurality of nozzles; and
(ii) a radiation means to irradiate an ink ejected on a recording media,
wherein the method comprises the steps of:
(a) ejecting droplets of the ink from the nozzles on the recording media, provided that:
(1) the ink contains a cationic polymerizable monomer and a photo acid generating agent;
(2) the recording media has a surface pH value of not less than 6; and
(3) a volume of each droplet is from 2 to 10 pl,
(b) irradiating the ejected droplets of the ink on the recording media within a period of time between 0.01 and 1.0 second after arrival of the droplets on the recording media.

2. The method for forming an image with an ink-jet printer of claim 1, wherein the ink comprises a colorant.

3. The method for forming an image with an ink-jet printer of claim 1, wherein the recording media has a surface pH value of not less than 7.

4. The method for forming an image with an ink-jet printer of claim 1, wherein the cationic polymerizable monomer contained in the ink is an oxetane compound.
